(19) United States
(12) Patent Application Publication
(10) Pub. No.: US 2006/0123138 A1
(43) Pub. Date: Jun. 8, 2006

(54) System and method for identifying and receiving data from an accessory

(76) Inventors: Jorge L. Perdomo, Boca Raton, FL (US); Daniel A. Baudino, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/006,293

(22) Filed: Dec. 7, 2004

(51) Int. Cl. G06F 3/00

(52) U.S. Cl. 710/2

(57) ABSTRACT

The invention concerns a method (300) and system (100) for identifying and receiving data from an accessory (110). In one arrangement, the method can include the steps of generating (312) at least one signal having at least one predefined frequency in which the predefined frequency corresponds to an identity of the accessory, receiving (314) the generated signals at a portable electronic device (112) and at the portable electronic device, identifying (320) the accessory based on the predefined frequency of the received signal. In another arrangement, the predefined frequencies correspond to a function performed by the accessory, and the method can further include executing (322) a corresponding function in the portable electronic device based on the predefined frequency that corresponds to the function performed by the accessory.

### BACKGROUND OF THE INVENTION

1. Field of the Invention

This invention relates in general to accessories for portable electronic devices and more particularly, those accessories that can exchange data with such devices.

2. Description of the Related Art

In today's marketplace, consumers have numerous portable electronic devices, such as cellular telephones and personal digital assistants, from which to choose. In an effort to increase their functionality, several manufacturers have developed accessories for such devices. For example, some companies produce headsets or other hands-free accessories that can be coupled to a mobile communications unit.

Because there are numerous accessories available, the issue of identifying the accessories arises. In particular, a mobile communications unit must recognize an accessory to which it is coupled to enable the mobile unit to operate with the accessory. Some mobile communications units have identification circuits that identify an accessory based on voltage values that are generated by a voltage divider network. Unfortunately, these identification circuits are permanent and as a result, cannot be altered. Also, these circuits do not facilitate the exchange of data between the accessory and the mobile communications unit.

### SUMMARY OF THE INVENTION

The present invention concerns a method for identifying and receiving data from an accessory. In one arrangement, the method can include the steps of generating at least one signal having at least one predefined frequency in which the predefined frequency corresponds to an identity of the accessory, receiving the generated signals at a portable electronic device and at the portable electronic device, identifying the accessory based on the predefined frequency of the received signal. In another arrangement, the predefined frequencies can correspond to a function performed by the accessory. The method can further include the step of executing a corresponding function in the portable electronic device that can be based on the predefined frequency that corresponds to the function performed by the accessory.

The portable electronic device can have a signal processor. The method can further include the step of programming the signal processor to enable the signal processor to identify previously-unidentifiable accessories. The programming step can also cause corresponding functions to be executed in the portable electronic device based on predefined frequencies that correspond to functions performed by the previously-unidentifiable accessory.

The method can also include the step of physically coupling the accessory to the portable electronic device. The receiving the generated signals step can include the step of receiving the generated signals at the portable electronic device over a signal interface that also carries audio signals. In addition, the method can further include the step of filtering the generated signals from the audio signals. In another arrangement, the predefined frequencies that correspond to the accessory function can be a subset of the predefined frequency that corresponds to the identity of the accessory. In addition, the function performed by the accessory can be associated with the monitoring of a physiological measurement in a living being.

The present invention also concerns a system for identifying and receiving data from an accessory. The system can include a signal generator in the accessory that can generate at least one signal having at least one predefined frequency in which the predefined frequency can correspond to an identity of the accessory. The system can also include a programmable signal processor that can be part of a portable electronic device and that is capable of being coupled to the signal generator. The signal processor can receive the generated signals and can identify the accessory based on the predefined frequency of the signal. The system can also include suitable software and circuitry for performing the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a system for identifying and receiving data from an accessory in accordance with an embodiment of the inventive arrangements;

FIG. 2 illustrates an example of a block diagram of the system of FIG. 1 in accordance with an embodiment of the inventive arrangements; and

FIG. 3 illustrates an example of a method for identifying and receiving data from an accessory in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for identifying and receiving data from an accessory. In one arrangement, the method can include the steps of generating at least one signal having at least one predefined frequency in which the predefined frequency corresponds to an identity of the accessory, receiving the generated signals at a portable electronic device and at the portable electronic device, identifying the accessory based on the predefined frequency of the received signal. In another arrangement, the predefined frequencies correspond to a function performed by the accessory. In addition, the method can further include the step of executing a corresponding function in the portable electronic device based on the predefined frequency that can correspond to the function performed by the accessory.

In one particular embodiment, the method can further include the step of physically coupling the accessory to the portable electronic device. In addition, the generated signals can be received at the portable electronic device over a signal interface that also carries audio signals, and the method can further include the step of filtering the generated signals from the audio signals. In another embodiment, the function performed by the accessory is associated with the monitoring of a physiological measurement in a living being.

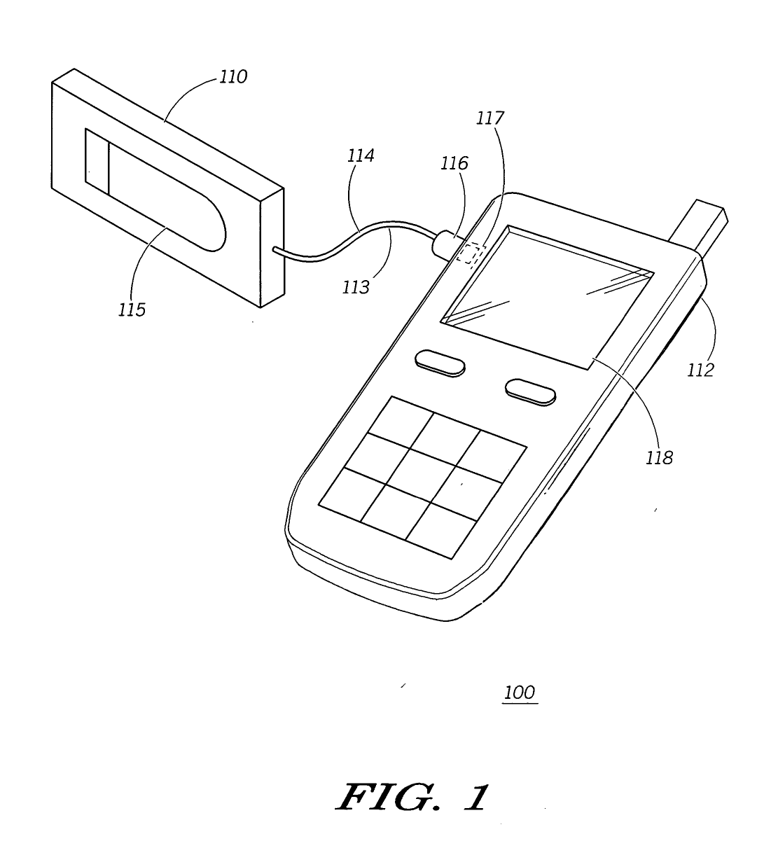

Referring to FIG. 1, a system 100 for identifying and receiving data from an accessory is shown. In one embodiment, the system 100 can include an accessory 110 and a portable electronic device 112. As an example, the portable electronic device 112 can be a mobile communications unit, such as a cellular telephone, although the invention is not so limited. The accessory 110 can be any device that can be coupled to the portable electronic device 112 for remotely performing functions and for transferring to the portable electronic device 112 audio (which can include voice) and/or data relating to these functions. The accessory 110 may also include an attachment mechanism 115, such as a clip, to permit a user to secure the accessory 110 to his or her clothing, for example. Examples of several suitable examples of an accessory 110 will be presented below.

In one arrangement, the accessory 110 can be coupled to the portable electronic device 112 through a connector 113 having a cable 114 and a plug 116. The plug 116 can be received by any suitable receptacle on the portable electronic device 112, including an audio jack 117. Of course, the invention is not so limited, as the accessory 110 can also be coupled to the portable electronic device 112 through a wireless connection. In either embodiment, audio (including voice) and/or data can be transmitted from the accessory 110 to the portable electronic device 112. In response, the portable electronic device 112 can perform several functions, including displaying relevant information over a display 118.

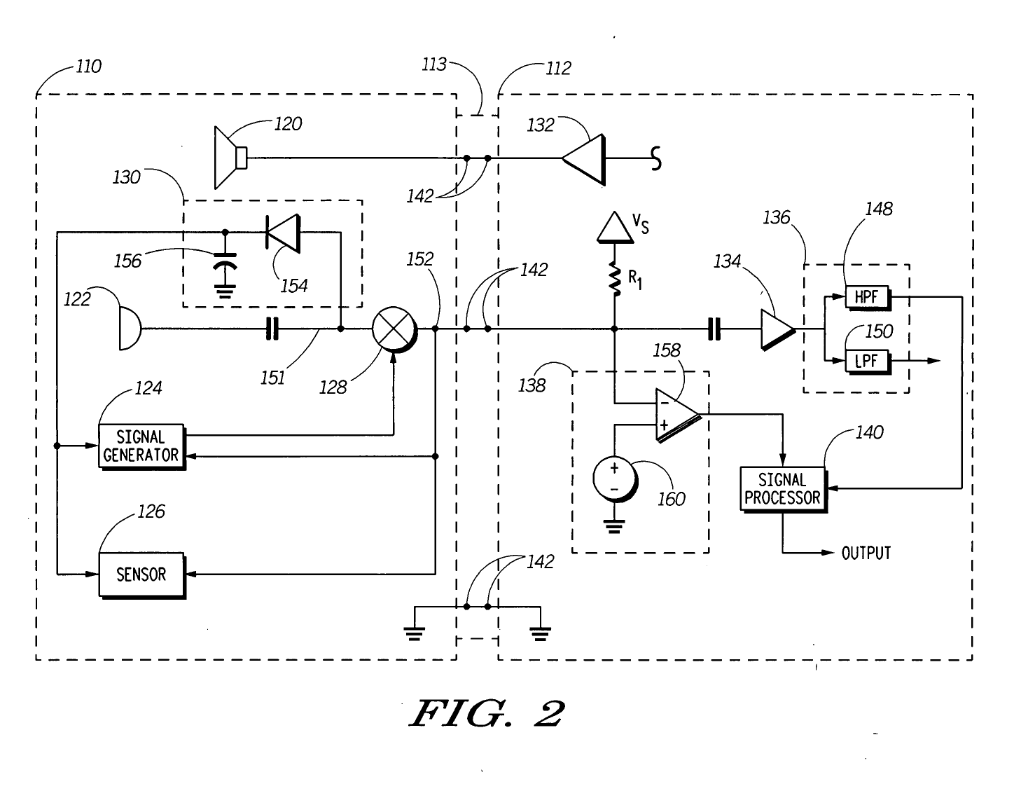

Referring to FIG. 2, a block diagram of an example of the system 100 is shown. Here, the system 100 can include the accessory 110 and the portable electronic device 112, and the accessory 110 can be coupled to the portable electronic device 112 through the connector 113. The accessory 110 may contain any number of components that enable it to facilitate communications. In one particular arrangement, the accessory 110 may also include components that permit it to monitor any suitable physiological characteristic. For example, the accessory 110 can have one or more speakers 120, one or more microphones 122, one or more signal generators 124 and one or more sensors 126 for sensing physiological characteristics. The accessory 110 may also include one or more mixers 128 and one or more power circuits 130.

In addition, the portable electronic device 112, which, as noted earlier, may be a mobile communications unit, can have one or more speaker amplifiers 132, one or more power supplies V_{S} having a pull-up resistor R₁, one or more microphone amplifiers 134 and one or more filters 136. The portable electronic device 112 may also contain one or more interrupt components 138 and one or more signal processors 140. Those of skill in the art will appreciate that the portable electronic device 112, when in the form of a mobile communications unit, may contain several other components to facilitate the transmission and receipt of wireless communications, including to the accessory 110 or any other suitable device.

The connector 113 may have any suitable number of signal interfaces 142, for coupling the accessory 110 to the portable electronic device 112. These signal interfaces 142 may be contacts of the plug 116 and the audio jack 117. As shown, the connector 113 is a three-pole connector, but it is understood that the invention is not so limited. In one arrangement, one of the signal interfaces 142 can carry audio (including voice), data and power signals between the accessory 110 and the portable electronic device 112. Such a configuration, as will be explained below, can enable the portable electronic device 112 to receive various accessories 110. The signal interface may also be any suitable circuitry for enabling wireless transmission of signals between the accessory 110 and the portable electronic device 112.

In the example shown in FIG. 2, the speaker amplifier 132 can be coupled to the speaker 120 through one of the signal interfaces 142, which can enable audio to be transmitted from the portable electronic device 112 to the accessory 110. In addition, one of the signal interfaces 142 can couple the microphone 122 to the microphone amplifier 134 (through the capacitors 144, 146), which can permit audio to be transmitted from the accessory 110 to the portable electronic device 112. Those of skill in the art will appreciate that the accessory 110, as described here, can enable a person to conduct a hands-free conversation, if so desired.

As noted earlier, the accessory 110 can include a mixer 128, and the mixer 128 can enable signals that the signal generator 124 generates to pass through the same signal interface 142 that the audio signals from the microphone 122 are carried over. In view of the signals from the signal generator 124 and the audio signals passing through the same signal interface 142, the filter 136 can include a high pass filter (HPF) 148 and a low pass filter (LPF) 150. The LPF 150 can permit the audio signals to pass through (e.g., signals that are at or below roughly 20 KHz, while the HPF 148 can allow signals over 20 KHz to pass through). As those of skill in the art will appreciate, the audio signals can proceed to components in the portable electronic device 112 for further processing. In addition, the signals from the HPF 148 can be transferred to the signal processor 140, where these signals, in one embodiment, can be digitized and further processed, as will be explained below.

The accessory 110 can also include a node 152, to which the signal generator 124, the sensor 126 and any other suitable component in the accessory 110 may be connected. The node 152 can be part of a line 151. The node 152 can enable the signal generator 124, the sensor 126 and any other suitable component to receive power from the power supply V_{S} through the signal interface 142. There may be some instances where the line 151 on which the node 152 is positioned is pulled low, which will be described later. To provide continuous power to, for example, the signal generator 124 and the sensor 126, the power circuit 130 can include a diode 154 and a capacitor 156, which can enable the power circuit 130 to act as a parasitic power source. In another arrangement, the accessory 110 can be equipped with its own power source, independent of any power source in the portable electronic device 112.

The interrupt component 138 can include a comparator 158 and a reference power source 160. When the line 151 is pulled low, the output of the comparator 158 can be low, which can trigger an interrupt at the signal processor 140. When the interrupt is generated, the signal processor 140 can be readied for processing signals from the HPF 148.

The signal generator 124 can be any suitable component that can generate signals of various predefined frequencies. In one arrangement, at least some of these signals can have frequencies above 20 KHz, although the invention is not so limited. In accordance with an embodiment of the inventive arrangements, these predefined frequencies can correspond to an identity of the accessory 110. For example, the accessory 110 can be assigned a predefined frequency, and when the accessory 110 is coupled to the portable electronic device 112, the signal generator 124 can generate a signal at this predefined frequency. The portable electronic device 112 can be configured to recognize the accessory 110 based on this predefined frequency.

The signal generator 124 can also generate signals having predefined frequencies that correspond to a function performed by the accessory 110. As an example, the function performed by the accessory 110 can relate to the measurement or monitoring of a physiological characteristic of a living being. As mentioned above, the sensor 126 can sense such physiological characteristics. The sensor 126 can then forward the results of its measurement or monitoring process to the signal generate 124. In response, the signal generator 124 can generate the signals with predefined frequencies that correspond to the measurement or monitoring performed by the accessory 110. These predefined frequencies that correspond to functions performed by the accessory 110 can be forwarded to the signal processor 140. The signal processor 140 can process these signals and can cause corresponding functions in the portable electronic device 112 to be executed. Specific examples of this process will be described below.

In accordance with the configuration described above, the signals generated by the signal generator 124 can share the line 151 with audio signals, such as those produced by the microphone 122. Such a design can minimize the number of signal interfaces 142 needed to operate the accessory 110. Depending on the bandwidth requirements, the signals from the signal generator 124 can be transmitted over the line 151 at the same time as the audio signals; alternatively, one of the audio signals or the signals from the signal generator 124 can be delayed if there is not enough bandwidth on the line 151. It is understood, however, that the invention is not limited to this particular design, however, as the signals from the signal generator 124 can be transmitted to the portable electronic device 112 over any other suitable line.

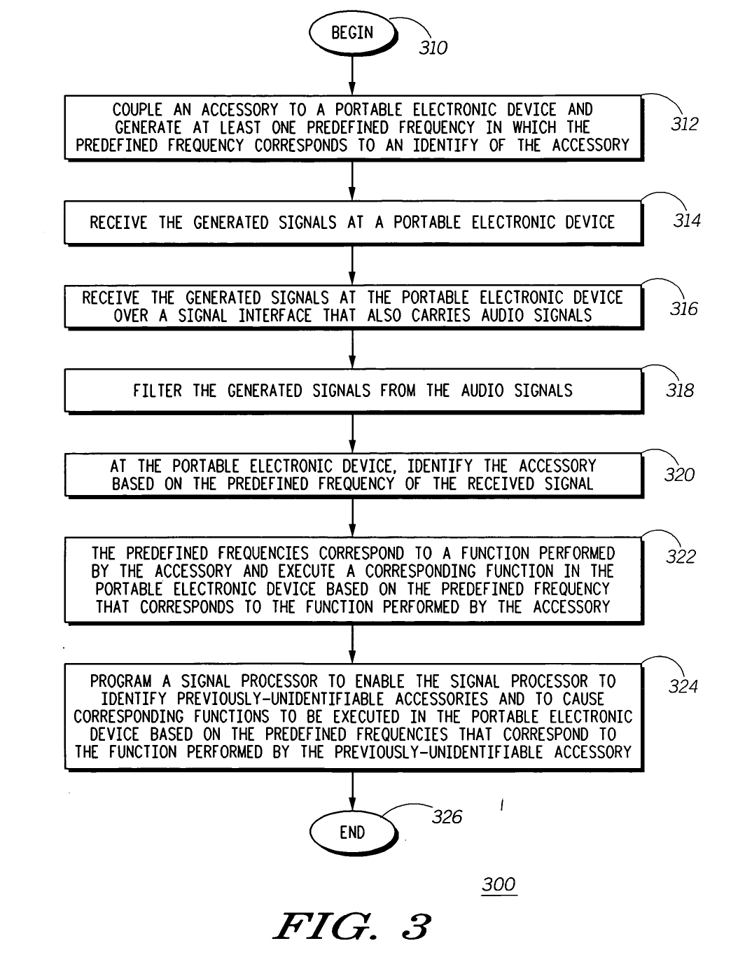

Referring to FIG. 3, a method 300 for identifying and receiving data from an accessory is shown. To describe the method 300, reference will be made to FIGS. 1 and 2, although it is understood that the method 300 can be implemented in any other suitable device or system. Moreover, the invention is not limited to the order in which the steps are listed in the method 300. In addition, the method 300 can contain a greater or a fewer number of steps than those shown in FIG. 3.

At step 310, the method 300 can begin. At step 312, an accessory can be coupled to a portable electronic device, and at least one signal having a predefined frequency can be generated. The predefined frequency can correspond to an identity of the accessory. At step 314, the generated signals can be received at a portable electronic device. The generated signals can be received at the portable electronic device, for example, over a signal interface that also carries audio signals, as shown at step 316. At step 318, the generated signals can be filtered from the audio signals. At step 320, at the portable electronic device, the accessory can be identified based on the predefined frequency of the received signal.

For example, referring to FIGS. 1 and 2, the accessory 110 can be coupled to the portable electronic device 112. The accessory 110 can be coupled to the portable electronic device 112 through the connector 113, although those of skill in the art will appreciate that the accessory 110 can be coupled to the portable electronic device 112 through some other suitable hard-wired connection or a wireless link. When so coupled, the signal generator 124 can power up and can generate a signal having a predefined frequency that corresponds to an identity of the accessory 110.

For instance, the accessory 110 may be a headset manufactured by a particular manufacturer. The signal generator 124 can generate a signal having a predefined frequency, such as 40 kHz. This 40 kHz signal can be transferred to the mixer 128 and can pass along the line 151 to the portable electronic device 112 through the signal interface 142. This 40 kHz signal can be higher in frequency than any audio signal that may pass along the line 151, and the HPF 148 can allow the predefined frequency signal to pass to the signal processor 140. The audio signals can be allowed to pass through the LPF 150 to those components that typically process such signals.

Once the signal processor 140 receives the 40 kHz, the signal processor 140 can digitize this signal and can access an internal or external table (not shown) to compare the predefined frequency with values in the table. The values in the table can correspond to various accessories, and based on this comparison, the signal processor 140 can then identify the accessory 110. The signal processor 140 can signal other components in the portable electronic device 112 with this identification.

This process can be used to identify numerous other accessories 110. For example, a headset produced by a different manufacturer or a different accessory, such as a health monitoring device, may have a higher or lower predefined frequency, as compared to 40 kHz. The signals having different predefined frequencies can be filtered and processed similar to the steps described above, and the signal processor 140 can identify the different accessories 110.

The duration of the predefined frequency signal can be of any suitable time frame, and when they are carried on the line 151, the output of the interrupt component 138 can go low in response to the drop in voltage on the line 151. By dropping low, the output of the interrupt component 138 can serve as an interrupt to the signal processor 140, which can permit the signal processor 140 to enter a deep sleep mode periodically. In addition, during the transmission of the predefined frequency signal, which results in voltage swings, the power circuit 130 can temporarily provide power to the signal generator 124, the sensor 126 or any other suitable component in the accessory 110. When the transmission ceases, the power supply V_{S} can once again provide power over the line 151. Of course, the accessory 110 may come equipped with its own internal or external power source.

Referring back to the method 300 of FIG. 3, at step 322, the predefined frequencies may correspond to a function performed by the accessory, and a corresponding function can be executed in the portable electronic device. This function in the portable electronic device can be based on the predefined frequency that corresponds to the function performed by the accessory. In addition, at step 324, a signal processor can be programmed to enable the signal processor to identify previously-unidentifiable accessories. The programming step 324 can also cause corresponding functions to be executed in the portable electronic device based on the predefined frequencies that correspond to the function performed by the previously-unidentifiable accessory. The method 300 can end at step 326.

For example, referring to FIGS. 1 and 2, it has been explained above that the signal processor 140 can identify various accessories 110 based on predefined frequencies generated by the signal generator 124. In another arrangement, the signal generator 124 can generate signals having predefined frequencies that correspond to functions performed by the accessory 110. Consider the following examples in which the accessory 110 facilitates communications and also serves as a health monitoring device.

The sensor 126 can be a sensor for measuring blood pressure and can rely on photoplethysmography to detect such pressure. As is known in the art, photoplethysmography is a process of applying a light source and measuring the light reflected by the skin. At each contraction of the heart, blood is forced through the peripheral vessels, producing engorgement of the vessels under the light source, thereby modifying the amount of light to the sensor 126. The sensor 126 can then record the resulting pressure waveform.

As another example, the sensor 126 can be a body fat sensor. The sensor 126 can employ a process called bioelectrical impedance analysis (BIA) to measure a user's body fat percentage. As is known in the art, in BIA, a small electrical current can be passed through a person's body, and the amount of impedance that the current faces can relate to how much fat-free mass a person's body has. The sensor 126 can have any suitable number of electrodes for conducting this process and can perform the calculations necessary to derive the body fat percentage.

Once the accessory 110 has been identified (e.g., as a blood pressure or body fat percentage monitor), the signal generator 124 can generate a signal having a predefined frequency that relates to the measurements taken by the sensor 126. In particular, in these examples, the signal generator 124 can generate a signal having a predefined frequency that corresponds to the measured blood pressure or the measured body fat percentage. These predefined frequencies can be a subset of the predefined frequency that was used to identity the accessory 110. Thus, if the accessory 110 is a blood pressure monitor and the predefined frequency used to identify this device was 40 kHz, the signal generator 124 can assign to the different systolic and diastolic pressures that it measures various frequencies that are around the 40 kHz frequency. For example, a certain systolic pressure can be assigned a frequency of 41 KHz and the corresponding diastolic pressure can be assigned a frequency of 39 kHz.

When the predefined frequency signals that correspond to the function performed by the accessory 110 reach the signal processor 140, the signal processor 140 can access an internal or external table that stores frequency values that correspond to the function performed by the accessory 110. Continuing with the blood pressure example, the signal processor 140 can access a table that stores frequency values that correspond to various systolic and diastolic blood pressures. The signal processor 140 can compare the received predefined frequencies with the stored frequencies and can determine the systolic and diastolic blood pressures.

The signal processor 140 can then cause a corresponding function to be executed in the portable electronic device 112. For example, here, the signal processor 140 can signal the display 118 to display these values to enable the user to ascertain his or her blood pressure.

The above-described process can also apply to the body fat percentage example. Thus, each particular body fat percentage, whether in whole percentages or segmented into whole percentages with fractional derivatives, can be assigned a particular frequency, which the signal generator 124 can produce. For example, if a person has a body fat percentage of 15% and the accessory 110 that performs this function is identified with a predefined frequency of 60 kHz, this particular measurement of 15% can be assigned a frequency of 65 kHz. Different body fat percentages can be assigned different frequencies. Once it receives the predefined frequency signals, the signal processor 140 can identify the body fat percentage monitor and can determine the user's body fat percentage. The signal processor 140 can then signal, for example, the display 118 to display this measurement.

Of course, the invention is not limited to these particular examples, as there are numerous other physiological characteristics that can be measured or monitored. For example, the sensor 126 can be configured to perform a galvanic skin response test or to determine a user's heart rate or temperature. Certainly, the invention is not limited to measuring or monitoring physiological characteristics, either. As an example, the accessory 110 can be designed to determine ambient temperature or other weather-related conditions or to measure a user's motion or physical whereabouts. In addition, the accessory 110 can include various user interfaces, such as a keypad, and functions selected by the user can be recognized and processed in view of the frequency distinction procedure explained above.

The signal processor 140 can be programmed to enable the signal processor to identify previously-unidentifiable accessories 110. The signal processor 140 can also be programmed to cause corresponding functions to be executed in the portable electronic device 112 based on the predefined frequencies that correspond to the function performed by the previously-unidentifiable accessory 110.

As an example, the accessory 110 may be a device that will produce a predefined frequency that the signal processor 140 does not initially recognize. The signal processor 140 can be programmed to recognize this predefined frequency, which can permit it to identify the new accessory 110. This procedure can enable the portable electronic device 112 to continuously recognize and accept new accessories 110. In addition, the signal processor 140 can be programmed to recognize predefined frequencies that correspond to any functions performed by the new accessory 110 in accordance with the description above. This step can enable the signal processor 140 to cause new, corresponding functions to be executed in the portable electronic device 112, also in accordance with the above process.

The signal processor 140 can be programmed through any suitable means, including via wireless transmission. For example, the portable electronic device 112 may include a transceiver (not shown) that can enable the portable electronic device 112 to receive updated software to permit the signal processor 140 to recognize and process the new signals. Other suitable means for performing this updating process are within contemplation of the inventive arrangements.

Although the system 100 in FIG. 2 is shown as having the signal generator 124 coupled to the line 151, it is understood that the invention is not so limited. For example, the signal generator 124 can be coupled to the line connected to the speaker 120 or some other suitable component. In addition, the signal generator 124 can have its own line and signal interface 142 for transferring signals to the portable electronic device 112. Additionally and as noted earlier, the accessory 110 can be wirelessly coupled to the portable electronic device 112, and the process of transmitting predefined frequencies can occur over a wireless link.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for identifying and receiving data from an accessory, comprising:
generating at least one signal having at least one predefined frequency, wherein the predefined frequency corresponds to an identity of the accessory;
receiving the generated signals at a portable electronic device; and
at the portable electronic device, identifying the accessory based on the predefined frequency of the received signal.

2. The method according to claim 1, wherein the predefined frequencies correspond to a function performed by the accessory and the method further comprises:
executing a corresponding function in the portable electronic device based on the predefined frequency that corresponds to the function performed by the accessory.

3. The method according to claim 2, wherein the portable electronic device has a signal processor and the method further comprises programming the signal processor to enable the signal processor to identify previously-unidentifiable accessories and to cause corresponding functions to be executed in the portable electronic device based on predefined frequencies that correspond to functions performed by the previously-unidentifiable accessory.

4. The method according to claim 1, further comprising physically coupling the accessory to the portable electronic device and wherein the receiving the generated signals step comprises receiving the generated signals at the portable electronic device over a signal interface that also carries audio signals.

5. The method according to claim 4, further comprising filtering the generated signals from the audio signals.

6. The method according to claim 2, wherein the predefined frequencies that correspond to the accessory function are a subset of the predefined frequency that corresponds to the identity of the accessory.

7. The method according to claim 2, wherein the function performed by the accessory is associated with the monitoring of a physiological measurement in a living being.

8. A system for identifying and receiving data from an accessory, comprising:
a signal generator in the accessory that generates at least one signal having at least one predefined frequency, wherein the predefined frequency corresponds to an identity of the accessory; and
a programmable signal processor that is part of a portable electronic device and that is capable of being coupled to the signal generator, wherein the signal processor receives the generated signals and identifies the accessory based on the predefined frequency of the signal.

9. The system according to claim 8, wherein the predefined frequencies correspond to a function performed by the accessory and the signal processor causes a corresponding function to be executed in the portable electronic device based on the predefined frequency that corresponds to the function performed by the accessory.

10. The system according to claim 9, wherein the signal processor is programmed to enable the signal processor to identify previously-unidentifiable accessories and to cause corresponding functions to be executed in the portable electronic device based on the predefined frequencies that correspond to the function performed by the previously-unidentifiable accessory.

11. The system according to claim 8, further comprising a signal interface that couples the accessory to the portable electronic device and wherein the signal interface carries the generated signals and audio signals.

12. The system according to claim 11, further comprising a filter, wherein the filter filters the generated signals from the audio signals.

13. The system according to claim 9, wherein the predefined frequencies that correspond to the accessory function are a subset of the predefined frequency that corresponds to the identity of the accessory.

14. The system according to claim 9, wherein the accessory further comprises a physiological measurement device and the function performed by the accessory is associated with the monitoring of a physiological measurement in a living being.

15. An accessory, comprising:
a signal generator that generates at least one signal having at least one predefined frequency, wherein the predefined frequency corresponds to an identity of the accessory; and
a signal interface coupled to the signal generator, wherein the signal interface sends the generated signals to a portable electronic device to permit the portable electronic device to identify the accessory based on the predefined frequency of the generated signals.

16. The accessory according to claim 15, wherein the predefined frequencies correspond to a function performed by the accessory and the portable electronic device executes a corresponding function based on the predefined frequency that corresponds to the function performed by the accessory.

17. The accessory according to claim 16, wherein the accessory further comprises a physiological measurement device and the function performed by the accessory is associated with the monitoring of a physiological measurement in a living being.

18. A portable electronic device that is capable of receiving an accessory, comprising:
a signal interface that receives signals generated at the accessory, wherein the generated signals have at least one predefined frequency and the predefined frequency corresponds to an identity of the accessory; and
a programmable signal processor that is coupled to the signal interface, wherein the signal processor receives the generated signals from the signal interface and identifies the accessory based on the predefined frequency of the signal.

19. The portable electronic device according to claim 18, wherein the predefined frequencies correspond to a function performed by the accessory and the portable electronic device executes a corresponding function based on the predefined frequency that corresponds to the function performed by the accessory.

20. The portable electronic device according to claim 19, wherein the signal processor is programmed to enable the signal processor to identify previously-unidentifiable accessories and to cause corresponding functions to be executed in the portable electronic device based on the predefined frequencies that correspond to the function performed by the previously-unidentifiable accessory.
